(19) United States
(12) Patent Application Publication
(10) Pub. No.: US 2011/0290708 A1
(43) Pub. Date: Dec. 1, 2011

(54) AQUARIUM FILTERING SYSTEM COMPRISING A FILTER ASSEMBLY DETACHABLY CONNECTABLE TO A DISTRIBUTION HOUSING

(75) Inventors: Philippe Francois RENOUD-GRAPPIN, Metz-Tessy (FR); Thierry Didier CADDET, Epagny (FR)

(73) Assignee: MARS FISHCARE EUROPE, METZ TESSY (FR)

(21) Appl. No.: 13/116,062

(22) Filed: May 26, 2011

Related U.S. Application Data
(60) Provisional application No. 61/348,419, filed on May 26, 2010.

(51) Int. Cl. A01K 63/04; B01D 27/04

(52) U.S. Cl. 210/236; 210/232; 210/483

(57) ABSTRACT

An aquarium filtering system including a distribution housing having at least two distribution ports, the distribution housing further having a water supplying orifice and a water evacuating orifice for connecting the distribution housing to the pump, the distribution ports being fluidly connected to a water supplying orifice or to a water evacuating orifice, the system further including a filter assembly having two filter ports and filtration means for filtering a water flow from one filter port to the other filter port, connection means for detachably connecting the filter assembly to the distribution housing so that, upon connection, each of the filter port is fluidly connected to a corresponding distribution port, and sealing means for, upon disconnection of the filter assembly, fluidly closing the filter ports and the corresponding distribution ports.

### CROSS REFERENCE TO RELATED APPLICATIONS

This application is related to and claims the benefit of U.S. provisional patent application Ser. No. 61/348,419 filed on 26 May 2010, the contents of which are hereby incorporated by reference in their entirety.

### TECHNICAL FIELD

The present invention concerns an aquarium filtering system.

### BACKGROUND

For filtering aquarium water, previously known aquarium filter devices usually utilize a pump housing and a filter assembly detachably mounted to the pump housing. The filter assembly typically comprises a filtering chamber containing filter cartridges which must be renewed or cleaned after a period of time. To service the filter cartridges, it is necessary to stop the pump before removing the filter cartridges from the filter assembly, thus requiring the user to manipulate electric plug with wet hands. Another disadvantage of known filtering aquarium devices is that a spillage can occur whenever the filter assembly is disassembled from the pump housing.

Moreover every known aquarium filtering device presents a predefined filtration capacity which decreases rapidly after a short period of time. Indeed, the cartridge clogs so that the water flow through the filter assembly dramatically decreases, altering the water quality.

### BRIEF SUMMARY

The present invention provides an aquarium filtering system which overcomes the above mentioned disadvantages of the previously known devices.

In that technical background, the present invention intends to propose an aquarium filtering system which is modular to offer different filtration capacities, and which can be serviced without risk of spillage or without turning the pump off.

For that purpose, the present invention relates to an aquarium filtering system intended to be connected to a water pump and comprising:
at least a distribution housing having at least two distribution ports, the distribution housing further comprising a water supplying orifice and a water evacuating orifice for connecting said distribution housing to said pump, each distribution port being fluidly connected to a water supplying orifice or to a water evacuating orifice,
at least a filter assembly having two filter ports and filtration means for filtering a water flow from one filter port to the other filter port,
connection means for detachably connecting said filter assembly to said distribution housing so that, upon connection, each of said filter ports is fluidly connected to a corresponding distribution port, and
sealing means for, upon disconnection of said filter assembly, fluidly closing said filter ports and the corresponding distribution ports.

An aquarium filtering system according to the present invention prevents any spillage of water when the filter assembly is removed, thanks to the sealing means which fluidly close, at the same time, the filter ports and the corresponding distribution ports upon disconnection of the filter assembly. Indeed, the water contained in the filter assembly cannot leak out when the sealing means are closed. In the same manner, the water flow pumped out by the pump cannot flow through the distribution ports, which are not connected to a filter assembly as they are closed by sealing means. The water pump does not therefore need to be turned off when a filter assembly is removed.

The aquarium filtering system is modular: the distribution housing can be connected to several filter assemblies in parallel, depending on the number of distribution ports it comprises. Connecting several filter assemblies to said distribution housing, either directly to two distribution ports or through a second distribution housing connected to said distribution housing permits to increase the filtration capacity of the aquarium filtering system. The parallel connection of filter assemblies increases the flow-rate of the pump and avoids a dramatic diminution of the flow-rate in case a filter assembly gets clogged, as it would be observed in a serial connection.

According to an embodiment, the aquarium filtering system further comprises controlling means for operating said sealing means in conjunction with connection means.

In an embodiment, the aquarium filtering system further comprises guiding means for guiding the connection of the filter assembly on the distribution housing.

According to a technical feature, said sealing means comprise at least four spool shut-off valves, said connection means comprising at least one locking arm, each one extending from one spool shut-off valve.

In an embodiment, the aquarium filtering system further comprises locking means for preventing the opening of sealing means when said filter assembly is disconnected from said distribution housing.

According to a technical feature, said distribution housing comprises a distribution chamber for supplying water flow to one first half of said distribution ports, said distribution chamber being located downstream of said water supplying orifice.

According to a technical feature, said distribution chamber comprises balancing means for balancing the pressure in each distribution port and/or in each supplying orifice connected to said distribution chamber. In case several filter assemblies are connected in parallel, the filtering capacity is increased as well as the water flow pump out by the pump. Connecting another distribution housing and/or another filter assembly increase the flow-rate in the distribution ports and/or supplying orifices and increase the flow-rate of the pump connected to the aquarium filtering system. Thereby, it has been observed that connecting two distribution housings together results in increasing the pump's flow-rate of at least 15%.

Furthermore, a parallel configuration, together with balancing means permit to balance the flow-rate in each filter assembly. Thus it avoids one filter assembly to get clogged before the others.

According to a possibility, said distribution housing comprises a collecting chamber for receiving water flow from another half of said distribution ports, said collecting chamber being located upstream of said water evacuating orifice.

According to a technical feature, said water supplying orifice and/or water evacuating orifice comprise a valve.

According to a technical feature, said filter assembly comprises a watertight body enclosing:
a supplying section, directly connected downstream of one filter port,
at least two filtering sections connected downstream in parallel of the supplying section, each filtering section being adapted to receive a basket for supporting a filter cartridge,
a collecting section directly connected upstream of another filter port and downstream of every filtering section.

According to a technical feature, the supplying section and collecting section are located in a bottom end of said filter assembly, wherein each filtering section extends from said supplying section or collecting section to an upper end, said filter assembly further comprising a collecting canal extending from the upper end to the collecting section.

According to technical feature, at least two distribution housings are connected together in parallel via the supplying orifices and evacuating orifices.

According to a possibility, the aquarium filtering system comprises at least a foldable filter cartridge for use in an aquarium, the filter cartridge including a plurality of panels with filter material, the filter cartridge having a folded condition such that the filter cartridge is relatively flat, and the filter cartridge panels being connected together along lateral edges in a polygonal shape other than a circle to form a space between opposing panels when in an open, operative condition such that the panels have only open opposing ends.

### BRIEF DESCRIPTION OF THE DRAWINGS

The invention will be clearly understood from the following description in which reference is made to the attached schematic drawing showing, as a non-limiting example, one embodiment of the aquarium filtering system.

FIG. 1 is a front perspective view of an aquarium filtering system comprising two distribution housings;

FIG. 2 is a bottom perspective view corresponding to FIG. 1;

FIG. 3 is a perspective view of distribution housing;

FIG. 4 is partial perspective view of a distribution housing wherein a cover has been removed;

FIG. 5 is a partial top view of FIG. 4 showing a distribution chamber and a collecting chamber;

FIG. 6 is a sectional view according to plan D of FIG. 1;

FIG. 7 is a bottom view of a filter assembly showing a part of sealing means and locking means;

FIG. 8 is a sectional perspective view according to plan A shown in FIGS. 1 and 2;

FIG. 9 is a sectional perspective view according to plan B shown in FIGS. 1 and 2;

FIG. 10 is a transversal sectional view of the filter assembly showing a collecting section and a supplying section;

FIG. 11 is a partial perspective view of controlling means and locking means taken aside;

FIG. 12 is a partial sectional and perspective view of the aquarium filtering system according to plan C of FIG. 1;

FIG. 13 is a longitudinal sectional view of the filter assembly showing the locking means when the filter assembly is disconnected form the distribution housing;

FIG. 14 is a longitudinal sectional view corresponding to FIG. 12 when the filter assembly is connected to the distribution housing;

FIG. 15 is a partial sectional and perspective view of a filter assembly containing filtration foam;

FIG. 16 is a perspective view of a basket containing a filter cartridge;

FIG. 17 is a perspective exploded view of the filter assembly of FIG. 16;

FIG. 18 is a front perspective view of the filter cartridge of FIGS. 16 and 17.

### DETAILED DESCRIPTION

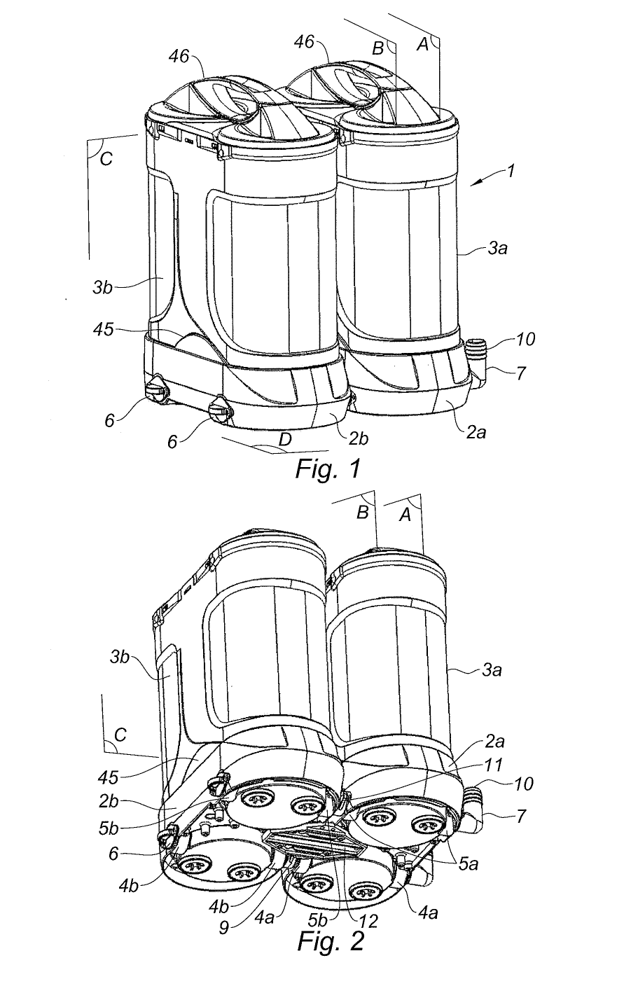

An aquarium filtering system 1 according to the invention is shown in FIGS. 1 to 18, in which the same elements are designed by the same reference numbers. The aquarium filtering system 1 is intended to be connected to a water pump installed in an aquarium, not shown in figures, and comprises, for instance, two distribution housings 2a, 2b in the embodiment shown in figures.

The aquarium filtering system 1 also comprises as much filter assemblies 3a, 3b as distribution housing 2a, 2b, each filter assembly 3a, 3b being detachably connected to one distribution housing 2a, 2b. Each distribution housing 2a, 2b is equipped with two water supplying orifices 4a, 4b and two water evacuating orifices 5a, 5b, as shown in FIG. 2. These supplying orifices 4a, 4b and evacuating orifices 5a, 5b can be closed up with caps 6 shown in FIGS. 1 and 2. When not plugged by a cap 6, each supplying orifice 4a of one distribution housing 2a can either be connected to a pipe 7 to form a water inlet 8 or to another supplying orifice 4b of another distribution housing 2b to form a first connection 9 as shown in FIG. 2. The water inlet 8 is intended to be connected to the water pump.

When not plugged by a cap 6, each evacuating orifice 5a of one distribution housing 2a can either be connected to a pipe 7 to form a water outlet 10 or to another evacuating orifice 5b of another distribution housing 2b to form a second connection 11 as shown in FIG. 2. The water outlet 10 is intended to evacuate the filtered water towards the aquarium.

When two or more distribution housings 2a, 2b are connected together as explained above, a connection plate 12 can be used to fasten both distribution housings 2a, 2b.

Whenever a distribution housing 2a is to be used alone, one supplying orifice 4a form an inlet 8 connected to the water pump and a cap 6 is used to plug the other supplying orifice 4a. In the same manner, one evacuating orifice 5a form an outlet 10 and the other evacuating orifice 5a is closed up with a cap 6.

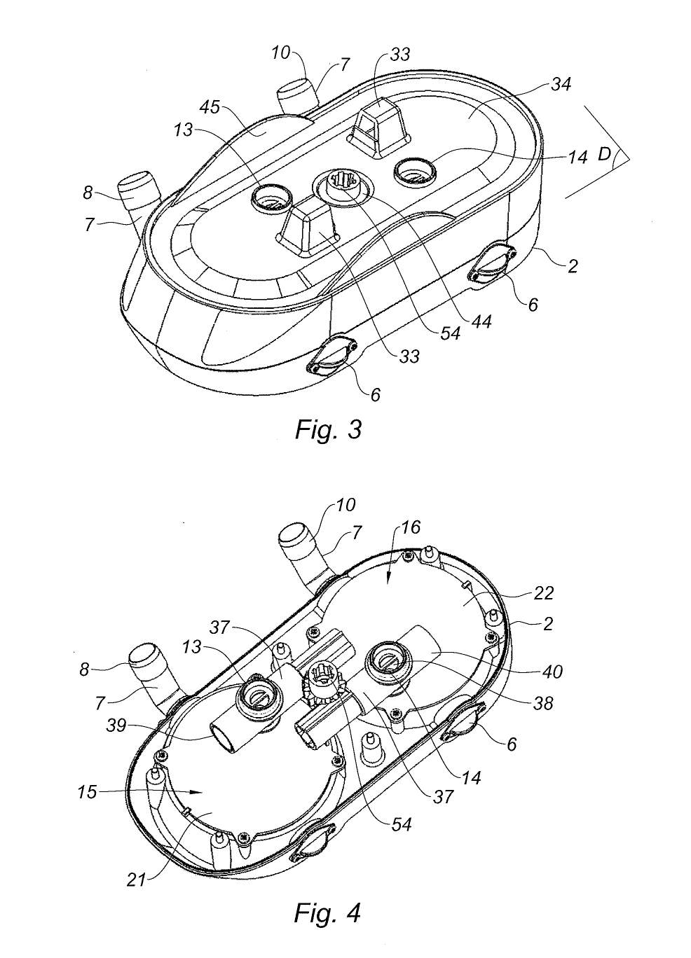

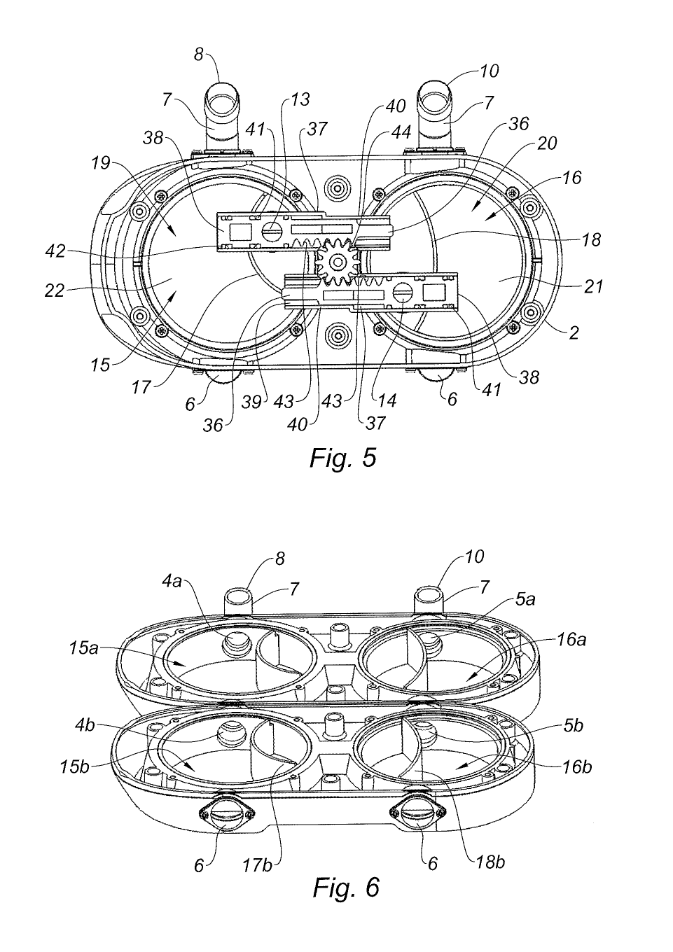

As shown in FIGS. 3 to 6, each distribution housing 2a presents at least two distribution ports 13, 14 for providing the filter assembly 3 with water flow. The two distribution ports 13, 14 are fluidly connected either to a supplying orifice 4a or to an evacuating orifice 5a, as shown in FIG. 6, through respectively a distribution chamber 15 or an evacuation chamber 16. Said distribution chamber 15 and evacuation chamber 16 are formed by hollow cylindrical volumes 19, 20 arranged in the distribution housing 2, which are fluidly connected to supplying orifices 4a, 4b and/or to evacuation orifices 5a, 5b and closed by chamber covers 21, 22 (shown in FIG. 4) in a watertight manner. For a better understanding of the figures, the chamber covers 21, 22 are not shown in FIGS. 5 and 6.

The distribution chamber 15 is designed to supply water flow to half of said distribution ports 13, 14 of the distribution housing 2a. When one supplying orifice 4a is connected to a tube 7 to form an inlet 8, the distribution chamber 15 is designed also to supply water flow to the other supplying orifice 4a. Thus, when the distribution housing 2a is fluidly connected to a second distribution housing 2b through supplying orifices 4a, 4b, as shown in FIG. 6, the distribution chamber 15a of the distribution housing 2a, which comprises the water inlet 8, feeds the distribution chamber 15b of the other distribution housing 2b as well as the distribution port 13a (not shown on FIG. 6).

The aquarium filtering system 1 further comprises balancing means for balancing the water flow in the distribution port 13, 14, in each supplying orifice 4a, 4b and in each evacuation orifice 5a, 5b. Such balancing means can, for instance, be achieved with curved walls 17a, 17b, 18a, 18b placed respectively in each distribution chamber 15a, 15b and in each evacuation chamber 16a, 16b. The curved walls 17a, 17b are oriented so as to present their extrados facing the supplying orifices 4a and the curved walls 18a, 18b are oriented so as to present their extrados facing the evacuation orifices 5a, 5b. Each curved wall 17, 18 present a high which is lightly inferior to the distribution chamber's high or to the evacuation chamber's high. The difference in high is calculated so as to define an aperture between the curved wall 17, 18 and the corresponding chamber cover 21, 22, said aperture having a surface about the same as the surface of the corresponding distribution port 13, 14.

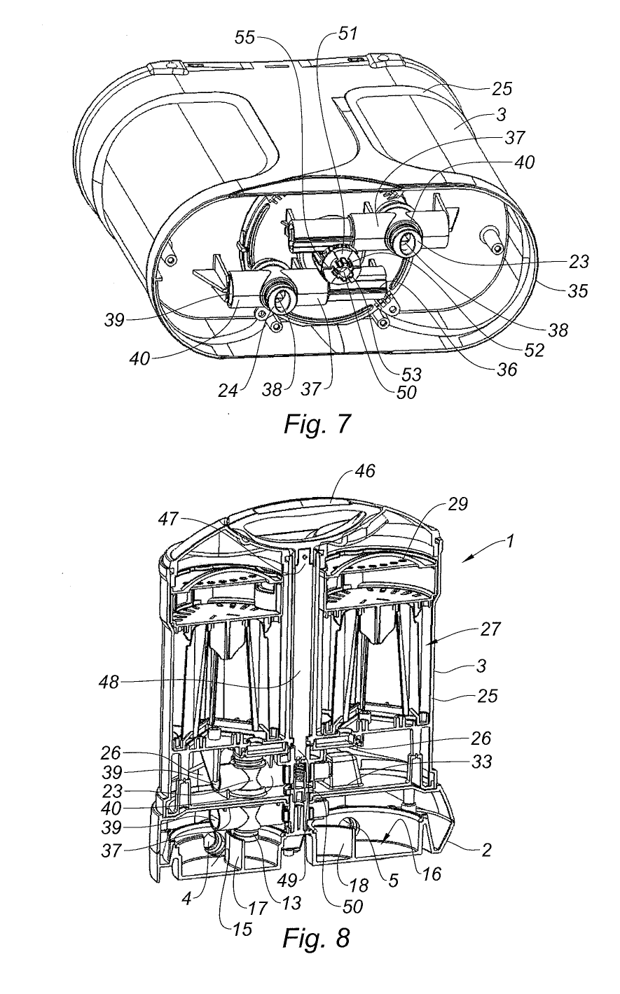

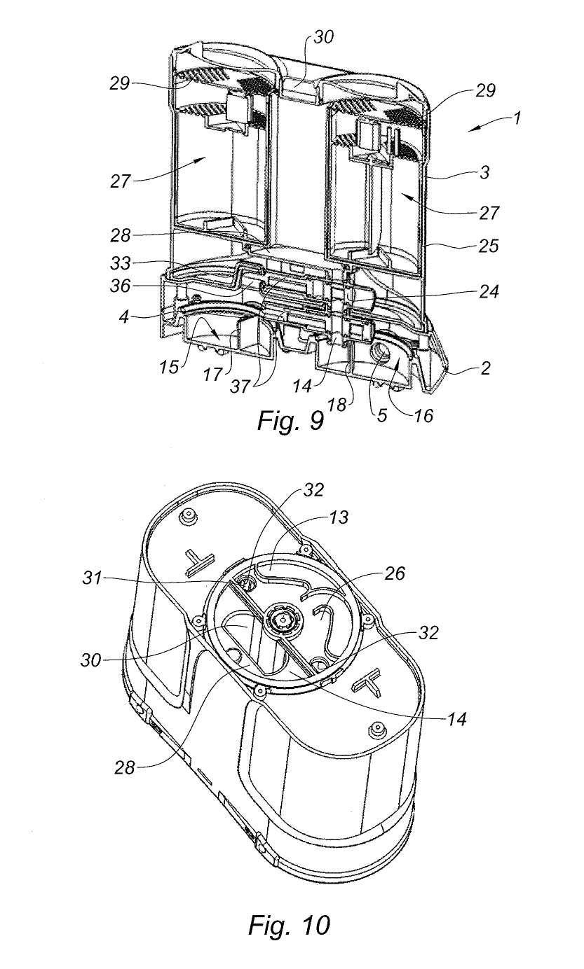

As shown in FIG. 7, each filter assembly 3 has two filter ports 23, 24 arranged so as to be fluidly connected to a corresponding distribution port 13, 14 upon connection of the filter assembly 3 with the distribution housing 2 (see FIGS. 8 and 9). As shown in FIGS. 8 and 9, the filter assembly 3 comprises a watertight body 25 enclosing a supplying section 26, two filtering sections 27 and a collecting section 28. The supplying section 26 and the collecting 28 section form together a cylindrical volume divided in two parts by a separation wall 31, shown in FIG. 10, in order to separate the supplying section 26 from the collecting section 28. The supplying section 26 is fluidly connected to the filter port 13 and feeds the two filtering sections 27 with equal water flows via two orifices 32 shown in FIG. 10. Each filtering section 27 extends along the body 25 and has, for example, a cylindrical form. Each filtering section 27 comprises filtration means for filtering the water flow, which can be constituted by, for example, filter cartridge and/or filtering foams. The upper end 29 of each filtering section 27, located at the opposite of the supplying section 26 and upstream the collecting section 28, is fluidly connected to a collecting canal 30 extending along the length of the body 25. The collecting canal 30, shown in FIGS. 9 and 10 emerges in the collecting section 28. The collecting section 28 allows the water flow to enter the evacuating chamber 16 via the filter port 24 and the corresponding distribution port 14. The water flow then exits the aquarium filtering system 1 via the outlet 10.

The aquarium filtering system 1 comprises also connection means for detachably connecting each filter assembly 3a, 3b to one distribution housing 2a, 2b so that, upon connection, each of said filter port 23, 24 is fluidly connected to the corresponding distribution port 13, 14. As shown in the FIGS. 3 and 7 to 9, the connection means comprise two housings forming two strikes 33 which stand-out of an upper surface 34 of the distribution housing 2, said upper surface 34 being adapted to support a lower flange 35 of the filter assembly 3 upon connection. The connection means further comprise two locking arms 36, movable between a locked position (shown in FIG. 9) and an unlocked position (shown in FIG. 5). The two locking arms 36 are positioned at the lower end of the filter assembly 3 so as to allow, when in unlocked position, the positioning of the filter assembly 3 on the distribution housing 2, in order to fluidly connect said filter ports 23, 24 with corresponding distribution ports 13, 14. The two locking arms 36 are also positioned so as to engage, when in locked position, the strikes 33 and put the filter assembly 3 and the distribution housing 2 together. To help position the filter assembly 3 on the distribution housing 2, the last comprises guiding means for guiding the connection. As shown in FIGS. 1 to 3, the guiding means comprise two projecting rims 45 spaced so as to control the approach of the filter assembly 3 toward the distribution housing 2 upon connection.

The aquarium filtering system 1 further comprises sealing means for, upon disconnection of said filter assembly 3, fluidly closing said filter ports 23, 24 and the corresponding distribution ports 13, 14. As shown in FIGS. 4, 5, and 7 to 9, the sealing means comprise four spool shut-off valves 37, each one controlling one distribution port 13, 14 or one filter port 23, 24. Instead of spool shut-off valve, the aquarium filtering system the sealing means could comprise at least two cylindrical cock-casings (not shown). In each spool shut-off valve 37 the flow is connect or sealed off by a cylindrical spool 38 sliding within a matching bore 39 of a valve body 40. The water tightness of each spool shut-off valve 37 is obtained with annular elastomeric seal 41 placed in grooves 42. The spool shut-off valves 37 of two distribution ports 13, 14 are placed adjacent and parallel to each other. Each cylindrical spool 38 is prolonged with a rack-rail 43 as shown in FIG. 5. The rack-rails 43 of two parallel spool shut-off valves 37 of the distribution housing 2 are meshed with a common toothed gear 44 so as to connect or seal off the water flow of the adjacent distribution ports 13, 14, simultaneously. In the same manner, the rack-rails 43 of two parallel spool shut-off valves 37 of the filter assembly 3 are meshed with a common toothed gear 44 so as to connect or seal off the water flow of the adjacent filter ports 23, 24 simultaneously.

In the embodiment described in figures, each locking arm 36 of the connection means forms an extension of a rack-rail 43 opposed of the cylindrical spool 38. In another embodiment, not illustrated in figures, the locking arms 36 could extend from the cylindrical spools 38 opposite of the corresponding rack-rails 43. In such configurations, the connection means and the sealing means are operated simultaneously.

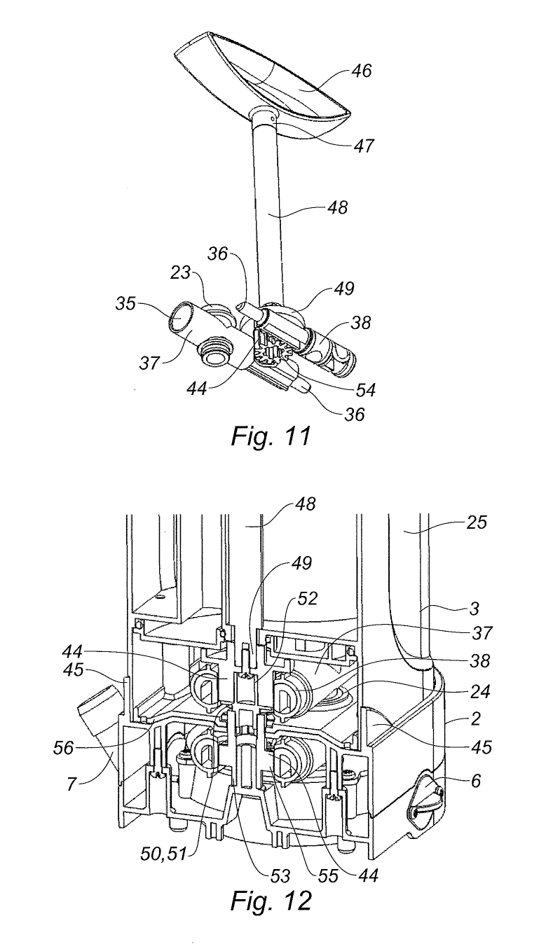

The aquarium filtering system 1 further comprises controlling means for operating said sealing means in conjunction with connection means. Such controlling means are partially illustrated aside in FIG. 11 and are shown in FIGS. 7, 8, 12 to 14. Referring to FIG. 11, said controlling means comprise a handle 46 mounted at an end 47 of a shaft 48 extending longitudinally through the filter assembly 3, as shown in FIG. 8, so that said handle 46 is placed above the upper end 29 to be easily accessible to the operator when the aquarium filtering system 1 is in use. The shaft's opposite end 49 of the end 47 is connected to the toothed gear 44 meshed with the rack-rails 43 of the spool shut-off valves 37, which are associated with the filter ports 23, 24. Upon rotation of said handle 46, the toothed gear 44 meshed with the rack-rails 43 mounted in the filter assembly 3 rotates and commands the opening or the closing of said filter ports 23, 24. While sliding the spools 38, each locking arm 36 are moved from their unlocked position to their locked position or the other way round. The controlling means further comprise a cylindrical element 50, shown in FIGS. 7 and 12, comprising a collar 51 and two tubular toothed walls 52 forming two pinions 53, which extend from each opposing side of said collar 51. The two pinions 53 are sized so as to fit in and mesh with a toothed circular cavity 54 of each toothed gear 44. Thus, upon connection of filter assembly 3 and distribution housing 2, the two pinions 53 mesh with the toothed gear 44 of the filter assembly 3 and the toothed gear 44 of the distribution housing 2. The rotation of the handle 46 further command the spool shut-off valves 37 associated with the distribution ports 13, 14.

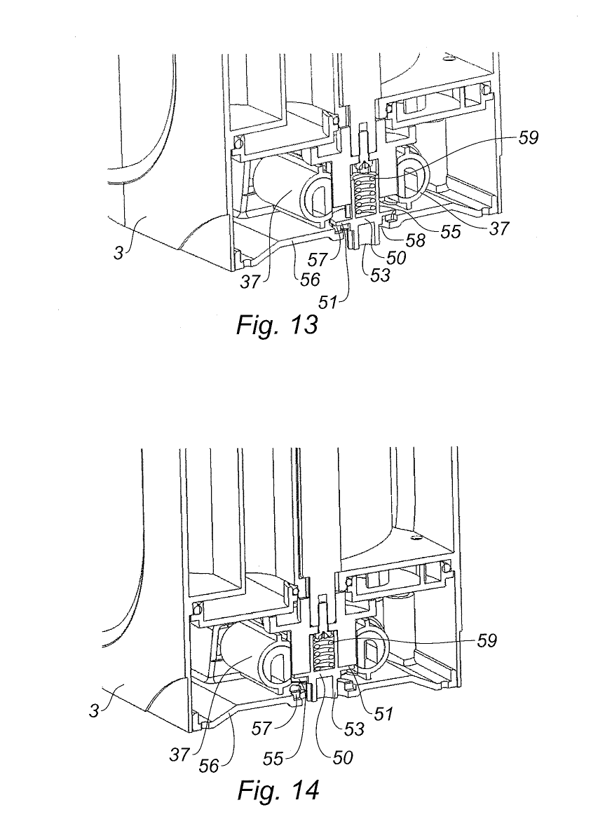

In order to avoid spillage of the water possibly contained in the filter assembly 3 through the filter ports 23, 24 when said filter assembly 3 is not connected to the distribution housing 2, the aquarium filtering system 1 further comprises locking means for preventing the opening of spool shut-off valves 37 of the filter assembly 3 when it is disconnected from said distribution housing 2. In the embodiment described in relation with the figures, the locking means comprise ribs 55, shown in FIG. 7, projecting from the side of the collar 51 intended to face the distribution housing 2. The filter assembly 3 comprises a lower cover 56, shown in FIGS. 12 to 14, covering the lower end of said filter assembly 3. Only the pinion 53 intended to mesh with the toothed gear 44 of the distribution housing 2 projects outside of the lower cover 56 through an orifice 58. The locking means also comprise grooves 57, shown in FIG. 12, made in the lower cover 56 and arranged so as to be able to engage with ribs 55 and block the rotation of cylindrical element 50 and of toothed gear 44 of the filter assembly 2. The locking means finally comprise spring means like a spring 59 shown in FIGS. 13, 14, compressed between the toothed gear 44 of the filter assembly 3 and the cylindrical element 50 so as to push said cylindrical element 50 toward the lower cover 56.

Upon disconnection of the filter assembly 3 as shown in FIG. 13, the spring 59 pushes the cylindrical element 50 and the ribs 55 become engaged with said grooves 57, thus blocking the rotation of the cylindrical element 50. Therefore, the toothed gear 44, the shaft 48 and the handle 46 cannot rotate.

Upon connection of the filter assembly 3 with the distribution housing 2, the pinion 53 extending outside the lower cover 56 comes up against the toothed gear 44 of the distribution housing 2. Approaching closer the filter assembly 3 from the distribution housing 2 results in said spring 59 being constricted. After completion of the connection, as shown in FIG. 14 (wherein the distribution housing 2 is not shown), the spring 59 is constricted and the ribs 55 and grooves 57 are no longer engaged. The cylindrical element 50 is therefore free to rotate.

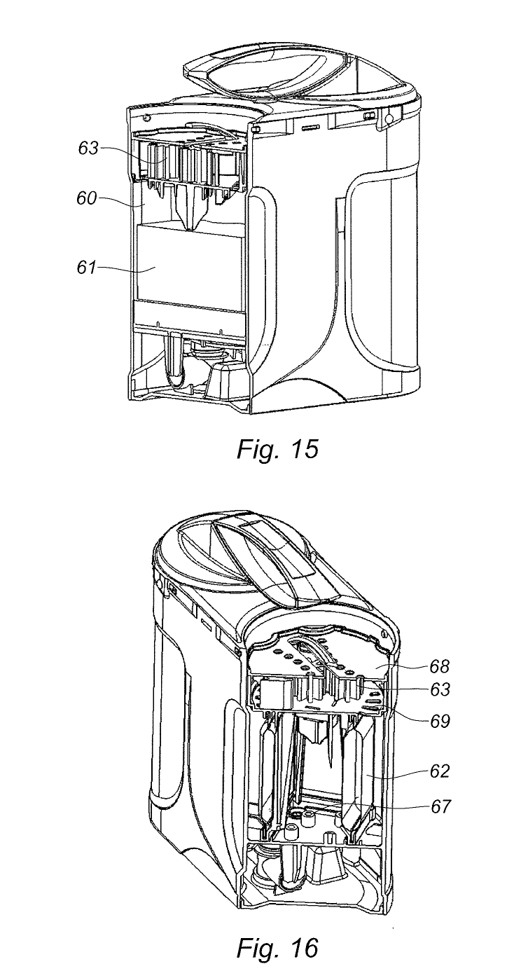

Referring now to FIGS. 15 to 18, the filtration means will be detailed. As mentioned above, each filtering section 27 can contain a basket 60 containing either filtration foam 61, as shown in FIG. 15, or filter cartridge 62, as shown in FIG. 16. Each filter basket 60 can further enclose biological filter media 63 as shown in FIGS. 15 and 16. The filter basket 60 comprises a feeding aperture 67, which allows the water flow entering the filtering section 27 to enter the basket 60. The water flow is then forced to percolate through the foam 61 or through the filter cartridge 62.

A filter cartridge particularly suitable for use within the filtering section 27 is the filter cartridge described in the U.S. Pat. No. 7,488,417 which is herein enclosed by reference. The enclosure by reference refers more particularly to the detailed description and to drawings. Such a filter cartridge 62, as shown in FIG. 18, includes a plurality of panels 64 filled with filter material, the filter cartridge 62 having a folded condition such that the filter cartridge 62 is relatively flat, and the filter cartridge panels being connected together along lateral edges 65 in a polygonal shape, for example square shape, to form a space 66 between opposing panels 64 when in an open, operative condition such that the panels 64 have only open opposing ends.

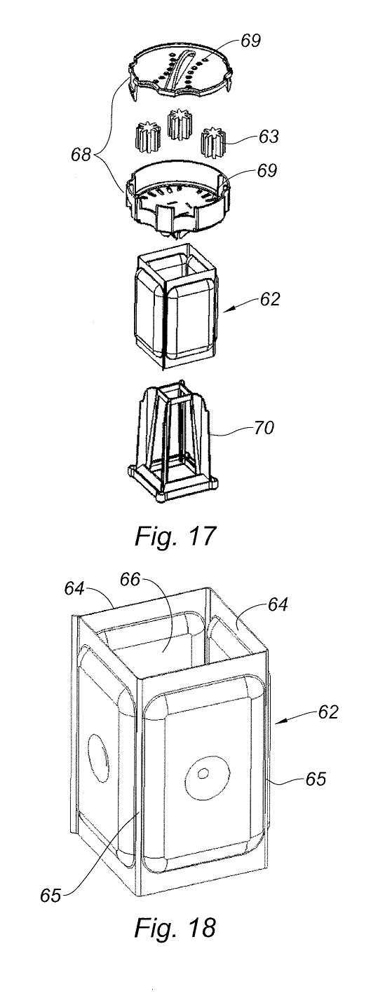

As shown on FIGS. 16 and 17, a tubular support 67 with opened end walls and side walls is inserted into the filter cartridge 62 in order to keep it in its open position. A cylindrical box 68 is mounted on the upper end of the tubular support 67. The opposite walls of the box comprise holes 69 delimiting water passages The box can further enclose biological filter media 63.

The aquarium filtering system 1 prevents any spillage of water when the filter assembly 3 is removed, thanks to the sealing means which fluidly close, at the same time, the filter ports 23, 24 and the corresponding distribution ports 13, 14 upon disconnection of the filter assembly 3. Indeed, the water contained in the filter assembly 3 cannot leak out when the sealing means are closed. In the same manner, the water flow pumped out by the pump cannot flow through the distribution ports 13, 14, which are not connected to a filter assembly 2 as they are closed by sealing means.

The aquarium filtering system 1 is modular: the distribution housing 2a can be connected in parallel to another distribution housing 2b. Connecting several filter assemblies to one distribution housing 2, either directly to two distribution ports 13, 14 or through a second distribution housing 2b permits to increase the filtration capacity of the aquarium filtering system 1. Connecting in parallel several filter assemblies permits to increase the flow-rate of the pump and improve the filtration capacity of the aquarium filtering system 1.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. Aquarium filtering system connectable to a water pump, comprising:
a distribution housing having at least two distribution ports, the distribution housing further comprising a water supplying orifice and a water evacuating orifice for connecting said distribution housing to said pump, each distribution port being fluidly connected to a water supplying orifice or to a water evacuating orifice,
a filter assembly having two filter ports and filtration means for filtering a water flow from one filter port to the other filter port,
connection means for detachably connecting said filter assembly to said distribution housing so that, upon connection, each of said filter port is fluidly connected to a corresponding distribution port, and
sealing means for, upon disconnection of said filter assembly, fluidly closing said filter ports and the corresponding distribution ports.

2. Aquarium filtering system according to claim 1, further comprising controlling means for operating said sealing means in conjunction with connection means.

3. Aquarium filtering system according to claim 1, further comprising guiding means for guiding the connection of the filter assembly on the distribution housing.

4. Aquarium filtering system according to claim 1, wherein said sealing means comprise at least four spool shut-off valves, said connection means comprising at least one locking arm, each one extending from one spool shut-off valve.

5. Aquarium filtering system according to claim 1, further comprising locking means for preventing the opening of sealing means when said filter assembly is disconnected from said distribution housing.

6. Aquarium filtering system according to claim 1, wherein said distribution housing comprises a distribution chamber for supplying water flow to one first half of said distribution ports, said distribution chamber being located downstream of said water supplying orifice.

7. Aquarium filtering system according to claim 6, wherein said distribution chamber comprises balancing means for balancing the pressure in each distribution port and/or in each supplying orifice connected to said distribution chamber.

8. Aquarium filtering system according to claim 1, wherein said distribution housing comprises a collecting chamber for receiving water flow from another half of said distribution ports, said collecting chamber being located upstream of said water evacuating orifice.

9. Aquarium filtering system according to claim 1, wherein said water supplying orifice and/or water evacuating orifice comprise a valve.

10. Aquarium filtering system according to claim 1, wherein said filter assembly comprises a watertight body enclosing
a supplying section, directly connected downstream of one filter port,
at least two filtering sections connected downstream in parallel of the supplying section, each filtering section being adapted to receive a basket for supporting a filter cartridge,
a collecting section directly connected upstream of another filter port and downstream of every filtering section.

11. Aquarium filtering system according to claim 10, wherein the supplying section and collecting section are located in a bottom end of said filter assembly, wherein each filtering section extends from said supplying section or collecting section to an upper end, said filter assembly further comprising a collecting canal extending from the upper end to the collecting section.

12. Aquarium filtering system according to claim 1, wherein at least two distribution housings are connected together in parallel via the supplying orifices and evacuating orifices.

13. Aquarium filtering system comprising a foldable filter cartridge for use in an aquarium, the filter cartridge including a plurality of panels with filter material, the filter cartridge having a folded condition such that the filter cartridge is relatively flat, and the filter cartridge panels being connected together along lateral edges in a polygonal shape other than a circle to form a space between opposing panels when in an open, operative condition such that the panels have only open opposing ends.
